(19) United States
(12) Patent Application Publication
(10) Pub. No.: US 2008/0149852 A1
(43) Pub. Date: Jun. 26, 2008

(54) MANUFACTURING METHOD OF SCINTILLATOR PANEL, SCINTILLATOR PANEL AND VACUUM EVAPORATION APPARATUS

(76) Inventors: Takehiko Shoji, Tokyo (JP); Mitsuru Sekiguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/945,965

(22) Filed: Nov. 27, 2007

(30) Foreign Application Priority Data
Nov. 30, 2006 (JP) JP2006-323330

(51) Int. Cl. G21K 4/00; B29C 65/64

(52) U.S. Cl. 250/483.1; 156/250; 156/510

(57) ABSTRACT

A method of manufacturing a scintillator panel comprising the sequential steps of: forming an electroconductive metal reflection layer on a polymer film substrate; forming a protective layer on the electroconductive metal reflection layer; cutting the polymer film substrate having thereon the electroconductive metal reflection layer and the protective layer into a prescribed size; forming a scintillator layer by a vacuum evaporation method on the protective layer of the polymer film substrate cut in the prescribed size to prepare a scintillator sheet; and sealing the scintillator sheet with sealing films provided above and below the scintillator sheet to prepare the scintillator panel, wherein static electricity is removed from the polymer film substrate through a cut surface of the electroconductive metal reflection layer when the scintillator layer is vacuum evaporated.

This application is based on Japanese Patent Application No. 2006-323330 filed on Nov. 30, 2006 in Japanese Patent Office, the entire content of which is hereby incorporated by reference.

### FIELD OF THE INVENTION

The present invention relates to a manufacturing method of a scintillator panel, a scintillator panel and a vacuum evaporation apparatus.

### BACKGROUND OF THE INVENTION

Hitherto, radiation images such as X-ray images are widely used for diagnosis of condition of disease on medical scenes. The radiation image by the intensifying screen-film system have been widely utilized on the medical scenes in the world as an imaging system having high reliability and excellent cost performance as a result of improvements in the high sensitivity and high image quality during the long history. However, the image information by such the system is analog information which cannot be freely processed nor electrically transmitted, different from digital image information which is becoming popular in these days.

Recently, radiation image detection apparatuses typically such as computed radiography (CR) and flat panel detector (FPD) have appeared. By such the systems, digital radiation image can be directly obtained and the image can be directly displayed on a displaying apparatus such as a cathode ray tube or a liquid crystal panel and image formation on the film is not always necessary. As a result of that, the digital X-ray image detection apparatus lowers the necessity of the image formation by the silver salt photographic system, whereby convenience for the diagnosis works in hospitals and clinics is largely increased.

As one of the digital technologies, the computed radiography (CR) has been accepted in the medical field. However, images by such the technology are not fully sufficient in image sharpness and also in the spatial resolution. Further, the image quality is not still in the level of those of the screen-film system. In addition, flat plate X-ray detector system (FPD) employing thin film transistor (TFT), described in such as “Amorphous Semiconductor Usher in Digital X-ray Imaging” by John Rawlands, Physics Today, 1997 November, p. 24, and “Development of a High Resolution, Active Matrix, Flat-Panel Imager with Enhanced Fill Factor” by 1.1. Anthonuk, SPIE, 1997, vol. 32, p. 2, as a further new digital X-ray image technology has been developed.

A scintillator panel composed of an X-ray fluorescent material capable of emitting light by radiation is used for converting radiation to visible light, and the use of a scintillator panel having high light emission efficiency is required for increasing a S/N ratio on the occasion of imaging at low radiation dose. The light emission efficiency of the scintillator panel generally depends on the thickness of the scintillator and the X-ray absorbing coefficient of the fluorescent material. However, the scattering of the emitted light in the scintillator is increased with increasing the thickness of the scintillator so as to cause lowering in the image sharpness. Accordingly, the thickness is determined according to the required image sharpness.

Cesium iodide has relatively high conversion ratio of X-ray to visible light and can be easily formed in columnar crystal structure by vacuum evaporation, therefore, the scattering of the emitted light in the crystal is reduced due to the light guiding effect of the crystal, whereby the thickness of the scintillator can be made thicker. However, the light emission efficiency is low when the cesium iodide is used alone. Therefore, examples of an X-ray fluorescent material include: a fluorescent material manufactured by vapor evaporating a mixture of CsI and sodium iodide (NaI) in an arbitral ratio for depositing in a form of sodium activated cesium iodide (CsI:Na) on a substrate as described in Examined Japanese Patent Publication No. 54-35060 and a fluorescent material manufactured by vapor depositing a mixture of CsI and thallium iodide (TlI) in an arbitral ratio for depositing in a form of thallium activated cesium iodide (CsI:Tl) on a substrate and then annealed for enhancing the visible light conversion efficiency.

Moreover, a method in which the substrate of the scintillator is made reflective such as that described in Examined Japanese Patent Publication No, 7-21560, a method in which an electroconductive metal reflection layer is provided on the substrate such as that described Japanese Patent Application Publication Open to Public Inspection (hereafter referred to as JP-A) No. 1-240887, and a method in which the scintillator is formed on a transparent organic layer covering a reflective metal thin layer provided on the substrate such as that described in JP-A No. 2000-355679 are proposed as the means for increasing the light output.

For providing the scintillator panel on a flat light receptive element surface, methods such as that described in JP-A Nos. 5-312961 and 6-331743 are known, but these methods are low in the production efficiency, and lowering in the image sharpness at the interface of the scintillator panel and the flat light receptive surface cannot be avoided.

Hitherto, as a manufacturing method of a scintillator by a vapor deposition, generally, a scintillator has been formed on a rigid substrate such as aluminum or amorphous carbon and then the whole surface of the scintillator has been covered by a protective layer. Furthermore, a scintillator panel composed of a scintillator deposited on a protective layer wholly covering a reflective metal layer provided on the substrate has been known, for example, refer to JP-A No. 2000-356679.

However, when a scintillator is formed on such a rigid substrate which cannot be freely bended, there may be a problem that a uniform image cannot be obtained when an image is detected by a light receptive surface of a flat panel detector due to the deformation of the substrate occurring on the occasion of pasting a scintillator panel with a flat light receptive element surface or due to the bending of the substrate at the time of the vacuum evaporation. Such the problem is enhancing accompanied with the recent trend of large sizing of the flat panel detector.

In order to avoid such the problem, a method have been proposed that a scintillator is formed on a flexible thermo-resistive polymer film by a vacuum evaporation method. However, the method has not been put into practical use since problem remains in the columnar shape of the formed crystals, for example, refer to Japanese Patent No. 3566926.

On such the situation, development of a fiat panel detector which is superior in the columnar shape of the crystals and low in the degradation of sharpness between the scintillator panel and the flat light receptive element surface is desired.

### SUMMARY OF THE INVENTION

An object of the present invention is to provide a manufacturing method of a scintillator panel which exhibits small deterioration of image sharpness when a radiation image is transferred from the scintillator panel to a flat light receptive element, a scintillator panel manufactured by the manufacturing method and a vacuum evaporation apparatus for manufacturing the scintillator panel.

One of the aspects of the present invention to achieve the above object is a method of manufacturing a scintillator panel comprising the sequential steps of: forming an electroconductive metal reflection layer on a polymer film substrate; forming a protective layer on the electroconductive metal reflection layer; cutting the polymer film substrate having thereon the electroconductive metal reflection layer and the protective layer into a prescribed size; forming a scintillator layer by a vacuum evaporation method on the protective layer of the polymer film substrate cut in the prescribed size to prepare a scintillator sheet; and sealing the scintillator sheet with sealing films provided above and below the scintillator sheet to prepare the scintillator panel, wherein static electricity is removed from the polymer film substrate through a cut surface of the electroconductive metal reflection layer when the scintillator layer is vacuum evaporated.

### BRIEF DESCRIPTION OF THE DRAWINGS

FIG. 1 is a schematic cross sectional view showing the constitution of the scintillator panel 10.

FIG. 2 shows an enlarged cross sectional view of the scintillator panel 10.

FIG. 3 schematic illustration showing the constitution of the vacuum evaporation apparatus 61.

FIG. 4 shows an enlarged drawing of the frame 70.

FIG. 5 is a schematic partial cutaway perspective view of the constitution of the flat panel detector 100.

FIG. 6 shows an enlarged cross sectional view of the imaging panel 51.

### DESCRIPTION OP THE PREFERRED EMBODIMENTS

The above object of the present invention is achieved by the following structures:

(1) A method of manufacturing a scintillator panel comprising the sequential steps of:

forming an electroconductive metal reflection layer on a polymer film substrate;

forming a protective layer on the electroconductive metal reflection layer;

cutting the polymer film substrate having thereon the electroconductive metal reflection layer and the protective layer into a prescribed size;

forming a scintillator layer by a vacuum evaporation method on the protective layer of the polymer film substrate cut in the prescribed size to prepare a scintillator sheet; and

sealing the scintillator sheet with sealing films provided above and below the scintillator sheet to prepare the scintillator panel, wherein

static electricity is removed from the polymer film substrate through a cut surface of the electroconductive metal reflection layer when the scintillator layer is vacuum evaporated.

(2) The method of Item (1), wherein the scintillator layer is formed using a raw material comprising cesium iodide and an additive containing thallium.
(3) The method of Item (1) or (2), wherein a thickness of the polymer film substrate is 50 to 500 μm.
(4) The method of any one of Items (1) to (3), wherein the polymer film substrate comprises polyimide (PI) or polyethylene naphthalate (PEN).
(5) The method of any one of Items (1) to (4), wherein the electroconductive metal reflection layer comprises at least one element selected from the group consisting of Al, Ag, Cr, Cu, Ni, Mg, Pt and Au.
(6) A scintillator panel manufactured by the method of any one of Items (1) to (5).
(7) A vacuum evaporation apparatus by which a scintillator layer is formed by a vacuum evaporation method according to the following steps:

forming an electroconductive metal reflection layer and a protective layer in that order on a polymer film substrate;

cutting the polymer film substrate into a prescribed size;

setting the polymer film substrate in a metal frame provided on a substrate holder, the metal frame being grounded; and

forming the scintillator layer on the polymer substrate by the vacuum evaporation method.

According to the present invention, a manufacturing method of a scintillator panel which exhibits small deterioration of image sharpness when a radiation image is transferred from the scintillator panel to a fiat light receptive element, a scintillator panel manufactured by the manufacturing method and a vacuum evaporation apparatus for manufacturing the scintillator panel can be provided.

The present invention will be described in detail below.

As a result of investigation by the inventors, it has been found that suitable columnar crystals having high independency can be obtained by providing an electroconductive metal reflection layer on a polymer film substrate and grounding the electroconductive metal reflection layer when the scintillator layer is formed by vacuum evaporation. It is supposed that the effect of the present invention can be obtained by canceling the hindrance to crystal growing caused by accumulation of static electricity on the polymer film, under the high degree of vacuum. The influence of the accumulated static electricity include: micro deformation of the flexible polymer film substrate; and disordering of the crystal growing direction of the crystals caused by static electrical repel.

The effect of the present invention is obtained by grounding a part of the electroconductive metal reflection layer provided on the polymer film substrate. Therefore, a protective layer is provided between the electroconductive metal reflection layer and the scintillator from the viewpoint of prevention of corrosion of the electroconductive metal reflection metal layer or of adhesion between the deposited crystals and the substrate. However, it is preferable for obtaining the effects of the present invention that a part of the electroconductive metal reflection layer is exposed and the layer is grounded at the exposed position on the occasion of the vacuum evaporation.

A part of the electroconductive metal reflection layer can be exposed at the cut surface by cutting the polymer film substrate in a prescribed size after subsequent formation of the electroconductive metal reflection layer and the protective layer on the polymer film substrate, whereby the manufacturing process can also be simplified by such the method. The prescribed size is a size of the substrate on which the electroconductive metal reflection layer and the protective layer are subsequently formed, which fits the metal frame in the vacuum evaporation apparatus.

Although the directly grounding the exposed portion of the electroconductive metal reflection layer at the cut surface is the most effective method, the effects of the present invention can be sufficiently obtained by arranging a grounded metal member within a distance of not more than 0.05 mm from the exposed portion so that the charge can be transferred between the electroconductive metal reflection layer and the metal member by electric discharge, provided that no insulating substance is placed between the electroconductive metal reflective layer and the metal member.

(Electroconductive Metal Reflection Layer)

The electroconductive metal reflection layer of the present invention can be used as a light reflection layer for outputting the light converted in the scintillator to outside and the electroconductive metal reflection layer is preferably formed by a metal having a high light reflectivity from the viewpoint of the utilizing efficiency of the emitted light. As the metal layer having high reflectivity, preferable is a material containing an element selected from the group consisting of Al, Ag, Cr, Cu, Ni, Mg, Pt and Au. Any method can be applied for forming the electroconductive metal reflection layer of the present invention, and, for example, a sputtering treatment using the above-mentioned material can be cited.

As the electroconductive metal of the present invention, one having a conductivity of not less than 6.0 S/m (Siemens per meter) is preferable and one having not less than 30 S/m is more preferable. Concretely, Al (40 S/m), Ag (67 S/m) and Au (46 S/m) are preferred with respect to the reflectivity and the conductivity.

(Scintillator)

The scintillator of the present invention is a fluorescent material capable of emitting electromagnetic waves of from 300 nm to 800 nm, namely principally visible light and extended over UV light to infrared light, by absorbing energy of the radiation.

As the material for constituting the scintillator, various fluorescent materials may be used and cesium iodide (CsI) is preferable because cesium iodide has relatively high conversion ratio of from X-ray to visible light and the columnar crystal structure of the fluorescent material can be easily formed by the vapor deposition so that the scattering of the emitted light in the crystal can be avoided by the light guiding effect, whereby the thickness of the scintillator layer can be increased.

Various activators are added since the light emission efficiency of CsI solely used is low. As described in Examined Japanese Patent Publication No. 54-35060, for example, a mixture of CsI and sodium iodide (NaI) in an arbitral ratio can be used. Moreover, CsI containing an activator such as indium (In), thallium (Tl), lithium (Li), potassium (K), rubidium (Rb) and sodium (Na) added by the vapor deposition process, such as that described in, for example, JP-A No. 2001-59859, is preferable.

In the present invention, an additive containing one or more kinds of thallium compounds and cesium iodide are preferably used as the raw material. The thallium activated cesium iodide (CsI:Tl) is preferable because it has wide emitting light wavelength range of from 400 nm to 750 nm.

Various thallium compounds including compounds having compounds oxidation number of +I and those having that of can be used and thallium bromide (TlBr), thallium chloride (TlCl) and thallium fluoride (TlF and TiF₃) are preferable in the present invention.

The melting point of the thallium compound relating to the present invention is preferably within the range of from 400 to 700° C. When the melting point is more than 700° C., the presence, of the additive in the columnar crystal is made ununiform and the light emission efficiency is lowered. The melting point in the present invention is that measured at ordinary temperature and pressure. The molecular weight of the thallium compound is preferably within the range of from 206 to 300.

In the scintillator relating to the present invention, the content of the additive is preferably decided to the optimum amount according to the objective properties, and is preferably from 0.001 to 50 mole-percent and more preferably from 0.1 to 10.0 mole-percent.

When the amount of the additive is less than 0.001 mole-percent of cesium iodide, the luminance of emitted light is little difference from that of the solely used cesium-iodide and objective light luminance cannot be obtained. When the content of the additive exceeds 50 mole-percent, the properties and the function of the cesium iodide cannot be maintained.

(Polymer Film Substrate)

Polyimide (PI) film or polyethylene naphthalate (PEN) film is preferable for the polymer film to be used as the polymer film substrate of the present invention from the view point of the thermal resistivity.

Regarding the problem that a uniform image cannot be obtained on the light receptive surface of the fiat panel detector due to the deformation of the substrate when the scintillator panel is pasted with the flat light receptive element or due to the bending of the substrate at the time of vacuum evaporation, it was found that the scintillator panel is deformed to fit the shape of the flat light receptive surface when a polymer film having a thickness of from 50 to 500 μm is used as the substrate, whereby high image sharpness can be obtained uniformly on the whole light receptive surface. However, it was also found that favorable columnar crystals cannot be obtained due to the electrostatic charge accumulated on the polymer film in the vacuum evaporation apparatus, when a polymer film is used as the substrate.

It was found by the inventors that such the problem can be overcome by using an electroconductive metal layer as the reflection layer and grounding it when the vacuum evaporation is carried out. It was further found that the exposed portion of the electroconductive metal reflection layer can be formed at the cut surface by cutting the polymer film substrate into the prescribed size after subsequently forming the electroconductive metal reflection layer and the protective layer on the polymer film substrate, thus the present invention could be attained.

As an alternative means for grounding the electroconductive metal reflection layer, a method can be applied in which a metal clip having sharp convexoconcave edges is attached on the protective layer side surface of the polymer substrate so as to break the protective layer and ground the electroconductive metal reflection layer.

(Protective Layer)

The protective layer to be used in the present invention is preferably formed by coating and drying a resin dissolved in a solvent. The resin is preferably a polymer having a glass transition point of from 30 to 100° C. is preferably from the viewpoint of the adhesion of the vapor deposited crystals with the substrate. Concretely, a polyurethane resin, a vinyl chloride copolymer, a vinyl chloride-vinyl acetate copolymer, a vinyl chloride-vinylidene chloride copolymer, a vinyl chloride-acrylonitrile copolymer, a butadiene-acrylonitrile copolymer, a polyamide resin, a poly(vinyl butyral), a polyester resin, a cellulose derivative such as nitrocellulose, a styrene-butadiene copolymer, various synthesized rubber type resins, a phenol resin, an epoxy resin, a urea resin, a melamine resin, a phenoxy resin, a silicone resin, an acryl type resin, and a urea-formamide resin are cited and the polyester resin is particularly preferred.

The thickness of the protective layer is preferably not less than 0.1 μm form the viewpoint of the adhesion and not more than 3.0 μm for maintaining the smoothness of the protective layer surface. The thickness of the protective layer is more preferably within the range of from 0.2 to 2.5 μm.

As the solvent to be used for forming the protective layer, a lower alcohol such as methanol, ethanol, n-propanol and n-butanol, a chlorine atom-containing hydrocarbon such as methylene chloride and ethylene chloride, a ketone such as acetone, methyl ethyl ketone and methyl isobutyl ketone, an aromatic compound such as toluene, benzene, cyclohexane, cyclohexanone and xylene, an ester of lower fatty acid and lower alcohol such as methyl acetate, ethyl acetate and butyl acetate, an ether such as dioxane, ethylene glycol monoethyl ester and ethylene glycol monomethyl ester and a mixture of them are usable.

(Sealing Film)

A sealing film is used for protecting the scintillator layer from the moisture and inhibiting the degradation of the scintillator layer and is constituted by a film having low moisture permeability. A poly(ethylene terephthalate (PET) film can be used for example. Other than the PET, polyester film, polymethacrylate film, nitrocellulose film, cellulose acetate film, polypropylene film and poly(ethylene naphthalate) film can be used. A layer constituted by laminating several layers of a vapor deposited film formed by vapor depositing a metal oxide on the above film can be used for suiting the necessary moisture preventing ability.

A fusible adhesion layer is formed on each of the surfaces of the substrate side and the scintillator layer side of the scintillator sheet for sealing by fusion with together. For the fusible adhesion layer, a resin film fusible by usually used impulse sealer can be used. For example, an ethylene-vinyl acetate copolymer (EVA) film, a polypropylene (PP) film and a polyethylene (PE) film are usable but the film is not limited to the above.

The scintillator sheet can be sealed by placing the sheet between the upper and lower side sealing films and the films are fused at the circumference portion under reduced pressure atmosphere.

(Preparation Method of Scintillator Panel)

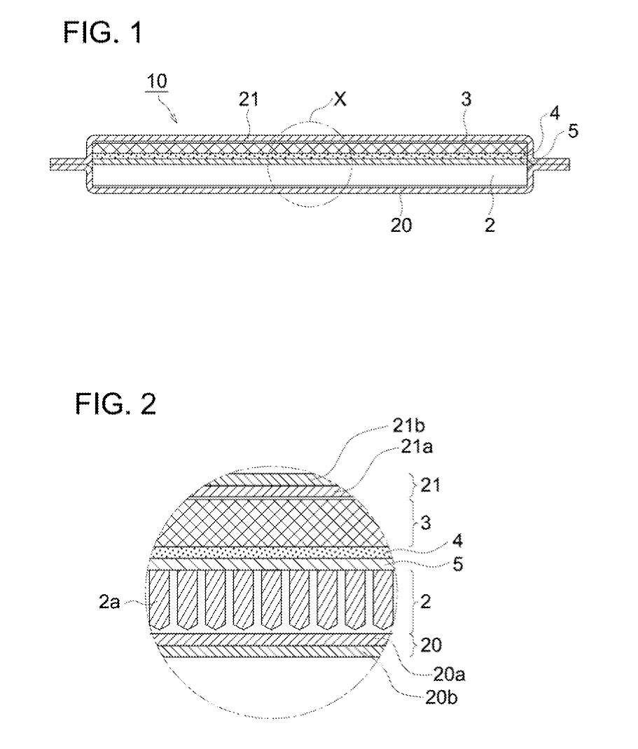

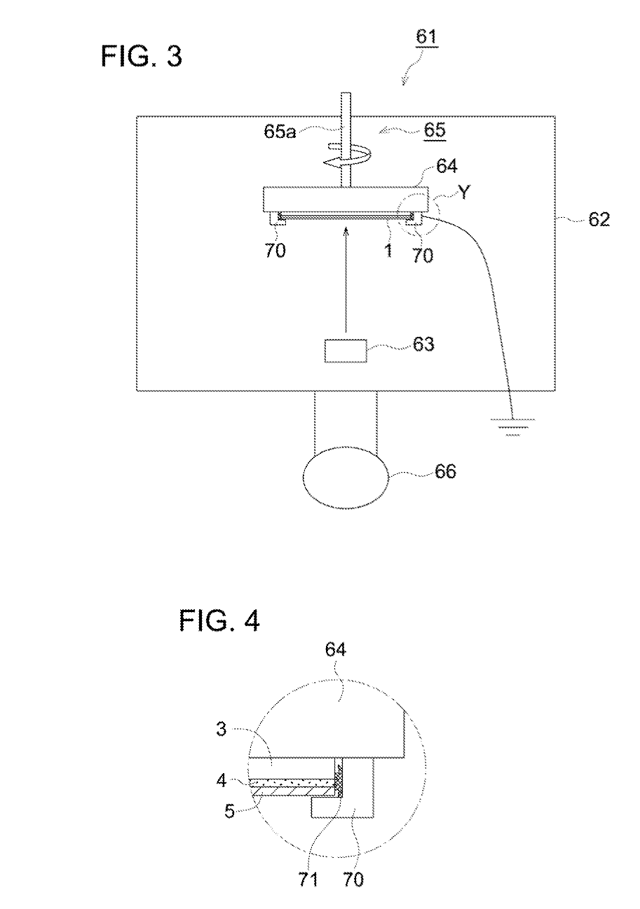

Typical example of preparation method of the scintillator panel of the present invention is described below referring the drawing. FIG. 1 is a cross section showing the outline of the constitution of the scintillator panel 10. FIG. 2 displays an enlarged cross section of the portion X of the scintillator panel 10. FIG. 3 is a drawing displaying the outline of the constitution of a vacuum evaporation apparatus 61.

The sealing films 20 and 21 are each constituted by polyethylene terephthalate (PET) films 20b and 21b on the surface of which metal oxide (SiO₂) is vapor deposited and fusible casting polypropylene (CPP) 20a and 21a.

The electroconductive metal reflection layer 4 and the protective layer 5 are successively provided between the polymer film substrate 3 and the scintillator layer 2.

(Vacuum Evaporation Apparatus)

As is shown in FIG. 3, the vacuum evaporation apparatus 61 has a box type vacuum chamber 62 in which a boat for vacuum evaporation 63 is placed. The boat 63 is a member in which the vaporising source material is charged and an electrode is connected to the boat 63. The boat is heated by Joule heat when electric current is applied through the electrode. On the occasion of producing the scintillator panel 10, a mixture containing cesium iodide and the activator compound is charged into the boat 63 and the mixture can be heated and vaporised by applying electric current to the boat 63.

An alumina crucible wound by a heater or a boat made of a metal with high melting point may be applied as the member to be charged by the raw materials.

In the vacuum chamber 62, a substrate holder 64 for holding the substrate 1 is arranged just above the boat 63. A heater, not shown in the drawing, is attached to the substrate holder and the substrate 1 held by the holder 64 can be heated by turning on the heater. Substances adsorbed on the surface of the substrate can be released or removed so that the formation of impurity layer between the substrate 1 and the scintillator layer (fluorescent material, layer) 2 formed on the substrate surface can be prevented, the adhesion between the substrate 1 and the scintillator layer 2 formed on the substrate surface can be strengthen and the properties of the scintillator layer formed on the surface of the substrate 1 can be controlled by heating the substrate 1.

A rotation mechanism 65 for rotating the substrate holder 64 is attached to the substrate holder 64. The rotation mechanism is constituted by a rotation axis 65a connected with the substrate holder 64 and a motor, not shown in the drawing, for driving the rotation axis, and the substrate holder 64 is rotated while facing to the boat 63 by driving the motor to rotate the rotation axis 65a.

A metal frame 70 for grounding the electroconductive metal reflection layer of the substrate 1 is attached to the substrate holder 64, FIG. 4 is an enlarged drawing of the portion Y in FIG. 3, where a contacting member 71 constituted by metal fibers (stainless steel fibers) is provided for making sure the removal of static electricity from the electroconductive metal reflective layer 4.

In the vacuum evaporation apparatus 61, a vacuum pump 66 is provided to the vacuum chamber 62 additionally to the above-mentioned. The vacuum pump 66 evacuates air in the vacuum chamber 62 and introduces gas into the vacuum chamber 62, and the gas atmosphere in the vacuum chamber 62 can be maintained at constant pressure by the action of the vacuum pump 66.

The above described vacuum evaporation apparatus 61 can be suitably applied in the manufacturing method of the scintillator panel 10. The method for manufacturing the scintillator panel 10 using the vacuum evaporation apparatus 66 will be described below.

<<Formation of Electroconductive Metal Reflection Layer>>

A thin layer of metal such as aluminum and silver as the electroconductive metal reflection layer is formed by sputtering on one surface of the substrate 1. Various kinds of polymer film on which aluminum layer is sputtered are distributed on the market, and such the films can be used as the substrate relating to the present invention.

<<Formation of Protective Layer>>

The protective layer is formed by coating and drying a composition prepared by dissolving a polymer binder into the foregoing organic solvent. As the polymer binder, a hydrophobic resin such as polyester rein and polyurethane resin is preferable from the viewpoint of anti-erosion ability of the electroconductive metal reflection layer.

<<Formation of Scintillator Layer>>

The substrate 1 on which the electroconductive metal reflection layer and the protective layer are provided as above is attached on the substrate holder 64 and a powder mixture containing cesium iodide and thallium iodide is charged in the boat 63 (preliminary process). It is preferable to set the distance between the boat 63 and the substrate 1 at a value within the range of from 100 to 1,500 mm and to carry out the later-mentioned vacuum evaporation while keeping the distance within the above range.

After the above preliminary process, air in the vacuum chamber 62 is exhausted to make a vacuum atmosphere of not more than 0.1 Pa in the vacuum chamber 62 (vacuum atmosphere formation process). Here, the “vacuum atmosphere” means an atmosphere with a pressure of not more than 100 Pa and the pressure is suitably not more than 0.1 Pa.

After that, inert gas such as argon is introduced into the vacuum chamber 62 and the interior of the vacuum chamber is maintained at the vacuum atmosphere of not more than 0.1 Pa. Then the heater of the substrate holder 64 and the motor of the rotation mechanism are driven so as to rotate the substrate 1 attached on the substrate holder 84 while heating and facing to the boat 63. The electroconductive metal reflection layer 4 of the substrate 1 is grounded by the metal frame 70.

In such the situation, the mixture containing cesium iodide and thallium iodide is heated at a temperature about 700° C. for designated time to evaporate the mixture by applying electric current to boat 63 through the electrode. As a result of that, innumerable columnar crystals 2a are gradually grown on the surface of the substrate 1 and a scintillator layer 2 having desired thickness is formed (vacuum evaporation process). Thus scintillator layer 2 relating to the present invention can be produced.

Each, of the columnar crystals 2a are more suitably formed in the vacuum evaporation process by the above production method of the scintillator layer 2 and the light guiding effect of the scintillator layer 2 is enhanced. Consequently, the sharpness of the scintillator layer 2 can be further raised compared with the usual one.

In the above-mentioned, various improvement and design variation may be applied within the range of not deviate the purport of the present invention.

The scintillator sheet prepared by forming the scintillator layer on the substrate 1 is placed between the sealing films and the edges of the sealing films where the films are touched are sealed under the vacuum atmosphere, thus scintillator panel 10 relating to the present invention can be produced,

(Plat Panel Detector)

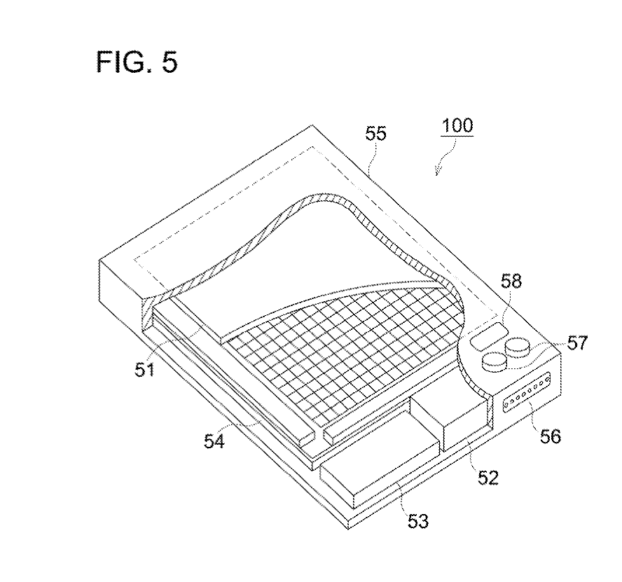

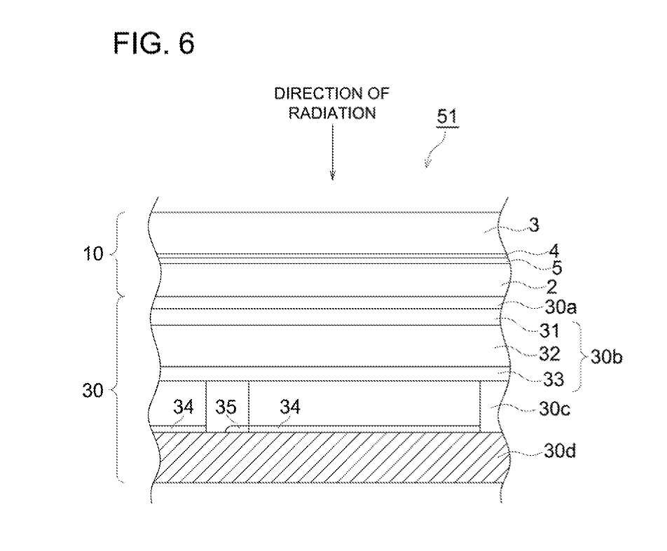

The constitution of a flat panel detector 100 having the scintillator panel 10 is described below referring FIGS. 5 and 6 as an application example of the scintillator panel 10. FIG. 5 is a partially broken oblique view showing the out line of the constitution of the flat panel detector 100, FIG. 6 is an enlarged cross section of imaging panel 51.

As is shown in FIG. 5, the flat panel detector 100 has a case 55 in which the imaging panel 55, a controlling means 52 for controlling the movement of the flat panel detector 100, a memory means 53 as a means for memorizing image signals generation from the imaging panel 51 using a rewritable exclusive memory such as a flash memory and a power source 54 as an electric power supplying means for supplying electric power necessary for driving the imaging panel 51 to obtain the image signals are provided.

On the case 55, a connector 36 for informing between the flat panel detector 100 and the exterior, an operation means 57 for changing the action of the fiat panel detector 100 and a displaying means 58 for displaying the completion of imaging preparation and that of writing of designated amount of the image signals into the memory 53 are provided according to necessity.

The flat panel detector 100 can be made portable by providing the power supplying means 54 and the memory 53 for memorizing the image signals of the radiation image to the flat panel detector 100 and making the flat panel detector 100 to be able to freely connecting and releasing through the connector 56.

As is shown in FIG. 6, the imaging panel 51 is constituted by the scintillator panel 10 and an output base board 30 for absorbing the magnetic wave from the scintillator panel 10 and generating the image signals.

The scintillator panel 10 is placed on the radiation incidental side and generates electromagnetic waves corresponding to the intensity of the incident radiation.

The output base board 30 is provided on the side opposite to the radiation incident face of the scintillator panel 10 and has a separation layer 30a, a photoelectric conversion element 30b, an image signal generation layer 30c and a basic board 30d in the order of from the scintillator panel side.

The separation layer 30a is a layer for separating the scintillator panel from the other layers.

The photoelectric conversion element 30b is constituted by a transparent electrode 31, a charge generation layer 32 for generating charge when excited by electromagnetic waves permeated through the transparent electrode, and a counter electrode 33 for being the counter electrode to the transparent electrode 31, which are arranged in the order of the transparent electrode, the charge generation layer 32 and the counter electrode 33 from the side of the separation layer 30a.

The transparent electrode is an electrode let passing electromagnetic waves to be subjected to photoelectric conversion, and is formed by an electroconductive transparent material such as indium, tin oxide (ITO), SnO₂ and ZnO, for example.

The charge generation layer 32 is formed as a thin layer on one side of the transparent electrode 21, which contains an organic compound capable of conversing light to electric current by separating electric charge by light, and an electron donor capable of generating charge and an electroconductive compound as an electron acceptor. In the charge generation layer 32, the electron donor is exited and releases electrons when irradiated by the electromagnetic waves and the released electrons are transferred to the electron acceptor so that charge namely carriers of positive hole and electron are generated.

As the electroconductive compound for the electron donor, p-type electroconductive polymer compounds can be cited. As the p-type electroconductive polymer, ones having a basic skeleton of polyphenylenevinylene, polythiophene, poly(thiophenevinylene), polyacetylene, polypyrrole, poly(p-penylene) or palyaniline.

As the electroconductive compound for the electron acceptor, n-type electroconductive compounds can be cited. As the n-type electroconductive compound, ones having a basic skeleton of pyridine are preferable and ones having a basic skeleton of polypyridine are particularly preferred.

The thickness of the charge generation layer is preferably not less than 10 nm and particularly preferably not less than 100 nm for maintaining the light absorbing amount and preferably not more than 1 μm and particularly preferably not more than 300 nm from the viewpoint of that the electric resistivity does not become too high.

The counter electrode 33 is provided on the side of the charge generation layer opposite to the side to which the light is irradiated. The material of the counter 33 can be selected from a usual metal such as gold, silver, aluminum and chromium, and the materials used for the transparent electrode 31, and a metal, alloy electroconductive compound and a mixture of them having a low work, function of not more than 4.5 eV is preferable for obtaining suitable property.

A buffer layer may be provided between the charge generation 32 and each of the electrodes (the transparent electrode 31 and the counter electrode 33) arranged on both sides of the charge generation layer 32. The buffer layer functions as a buffer zone for preventing reaction between the charge generation layer with the transparent electrode or the counter electrode. The buffer layer is formed by lithium fluoride and poly(3,4-ethylenedioxythiophene), poly(4-stylenesulfonate) or 2,9-dimethyl-4,7-diphenyl[1,10]-phenanthroline for example.

The image signal generation layer 30c accumulates the charge obtained by the photoelectric conversion 30b and generates signals according to the accumulates charge, which is constituted by a condenser 34 as the charge accumulation element for accumulating the charge of each pixels obtained by the photoelectric conversion element and a transistor 35 as an image signal generation element.

As the transistor 35, for example, a thin film transistor (TFT) is used. The TFT may be an inorganic type transistor usually used for liquid crystal displays or that using an organic semiconductor, and preferably a TFT formed on plastic film. As the TFT formed on the plastic film, ones of amorphous silicon type are known, and a TFT formed on a flexible plastic film by arranging micro CMOS (nanoblocks) formed by silicon single crystal on an embossed plastic film which is manufactured by Fluidic Self Assembly (FSA) technology developed by Alien Technology Corp. may be applied.

TFTs using organic semiconductor such as those described in Science, 283, 822 (1999), Phys. Lett. 771488 (1998) and Nature, 403, 521 (2000) may be also used.

As the transistor 35 to be used in the present invention, the TFT manufactured by the FSA technology and that using the organic semiconductor are preferable and the TFT using the organic semiconductor is particularly preferred. When the TFT is constituted by the organic semiconductor, any vacuum evaporation equipment to be used for manufacturing the TFT using silicon is not necessary and the TFT can be formed by applying printing technology and ink-jet technology. Therefore, the production cost can be lowered and the transistor can be formed on a plastic substrate having low resistivity against heat since processing temperature can be lowered.

A collector electrode, not shown in the drawing, is connected to the transistor 35, which accumulates the charge generated by the photoelectric conversion element 30b and functions as one electrode of the condenser 34. The charge generated by the photoelectric conversion element 30b is accumulated by the condenser and the accumulated charge is readout by driving the transistor 35. Namely, the signal of each of the pixels of the radiation image can be output by driving the transistor 35.

The base board 30d functions as the support of the imaging panel 51 and can be constituted by a material the same as that, of the substrate 1.

The function of the flat panel detector 100 is described below.

Incident radiation to the fiat panel detector 100 permeates in the direction of from the side of the scintillator panel 10 of the imaging panel 5 to the base board 30d. The scintillator layer 2 in the scintillator panel 10 absorbs energy of the radiation and generates electromagnetic waves corresponding to the intensity of the radiation. Among the generated electromagnetic waves, the electromagnetic waves irradiated to the output base board 30 arrives to the charge generation layer 32 through the separation layer 30a and the transparent electrode 31 of the output board 30. The electromagnetic waves are absorbed by the charge generation layer 32 and pairs of positive hole and electron (charge separation state) are formed corresponding to the intensity of the electromagnetic waves.

After that, the generated positive holes and electrons are each transferred to different electrodes (the transparent electrode layer and electroconductive layer) by the interior electric field formed by bias voltage applied from the power source 54. As a result of that photocurrent is generated.

Then the positive holes transferred to the counter electrode are accumulated in the condenser 34 of the image signal generation layer 30c. The positive holes accumulated in the condenser 34 generates image signals when the transistor 35 connected to the condenser 34 is driven and the generated image signals are memorized by the memory means 53.

The photoelectric conversion efficiency can be raised, the S/N ratio of the radiation image taken by low dosage imaging can be improved and occurrence of unevenness of the image and line-shaped noises can be prevented by the flat panel detector 100 since which has the above-mentioned scintillator panel 10.

### EXAMPLES

The present invention will be described in detail below referring examples but the present invention is not limited thereto.

### Example 1

### Preparation of Scintillator Panel

(Preparation of Substrate A Having Electroconductive Metal Reflection Layer)

Aluminum was sputtered on polyimide films (Upilex manufactured by UBE Industries Ltd.) having thicknesses of 25, 50, 75 and 125 μm to form an electroconductive metal reflection layer. Aluminum was sputtered in the same manner as above on polyimide boards having a thicknesses of 250, 500 and 750 μm each prepared by laminating the above polyimide films (Upix Board manufactured by UBE Industries Ltd.) to form an electroconductive metal reflection layer.

(Preparation of Substrate B Having Electroconductive Metal Reflection Layer)

Aluminum was sputtered on polyethylene naphthalate films having thicknesses of 25, 50, 75 and 125 μm to form an electroconductive metal reflection layer.

(Preparation of protective layer)

| | |
|---|---|
| Vylon 630 (high molecular weight polyester resin | 100 parts by weight |
| manufactured by Toyobo Co., Ltd.) | |
| Methylethyl ketone (MEK) | 100 parts by weight |
| Toluene | 100 parts by weight |

The above composition was mixed and dispersed by a beads mill to prepare a coating liquid for subbing coating. The coating liquid was coated by a bar coater on the aluminum sputtered surface of the substrates A and B so as to be make the dry layer thickness to 1.0 μm and dried at 100° C. for 8 hours to form a protective layer.

The substrates A and B having the protective layer were each cut in to the size for fitting the metal frame 70 of the holder 64 of the vacuum evaporation apparatus of FIG. 3, and set on the frame 70.

(Formation of Scintillator Layer)

Fluorescent material (CsI:0.003Tl) was deposited on the protective layer side of the substrate to form a scintillator layer (fluorescent layer) by the vacuum evaporation apparatus shown in FIG. 3.

Namely, the above fluorescent raw materials were charged in the resistor heating boat and the substrate was attached on the metal frame of the rotatable substrate holder, and the distance between the substrate and the vaporizing source was adjusted to 400 mm.

After that, the air in the vacuum evaporation apparatus was once evacuated and Ar gas was introduced to adjust the vacuum degree to 0.5 Pa, then the temperature of the substrate was held at 100° C. while rotating the substrate at a rate of 10 rpm. Then the fluorescent material was vapor deposited by heating the resistor heating boat and the deposition was completed when the thickness of the scintillator layer came up to 450 μm to obtain a scintillator sheet.

Comparative scintillator sheets were prepared without eliminating the electric charge of the electroconductive metal reflection layer by using no metal frame 70.

(Preparation of Sealed Film)

A laminated film of polyethylene terephthalate film (pet) and casting polypropylene (CPP) film was used for the sealing film of the scintillator side of the scintillator sheet. The method for lamination of the films was dry lamination and the thickness of the adhesive layer was 1 μm. The adhesive was a two liquids reaction type urethane adhesive. As the sealing film for the substrate side, the same sealing film as used for the scintillator layer side of the scintillator sheet was used.

(Sealing of Scintillator Sheet)

The sealing films were placed on both sides of the scintillator sheet (9 cm×9 cm) and fused at the circumference portion by an impulse sealer to seal the scintillator sheet. The distance from the fused portion to the circumference of the scintillator sheet was 1 mm. The width of the heater of the impulse sealer was 8 mm.

(Evaluation)

Each of the prepared samples was set on the CMOS flat panel (X-ray CMOS camera system Shad-o-Box 4KEV manufactured by Rad-icon Imaging Corp.) and the image sharpness of the 12 bit output data was measured by the following method. The results of evaluation measured by the following method are shown in Table 1.

The flat light receptive element and the scintillator panel were fixed by placing sponge sheets on the carbon plate of the radiation incident window and the radiation incident side of the scintillator panel (the radiation incident side having no fluorescent layer) and lightly pressing the flat light receptive element onto the scintillator panel.

<Evaluation Method of Sharpness>

The backside (the face on which the scintillator is not formed) of each sample was irradiated with an X-ray of tube voltage of 80 KVp through a lead MTF chart and the image data were detected by a CMOS fiat panel and recorded on a hard disc. And then the records on the hard disc were analyzed and the modulation transfer function (MET) at a spatial frequency of 1 cycle/mm of the X-ray image recorded on the hard disc was determined as the indicator of the image sharpness. In the table, higher MFT value corresponds to superiority in the sharpness namely superior in the columnar property and high in the light guiding ability. MFT is an abbreviation of Modulation transfer Function.

TABLE 1

| Scintillator | | | Thickness of substrate/MFT | | | | | | |
|---|---|---|---|---|---|---|---|---|---|
| panel | Substrate | Grounding | 25 μm | 50 μm | 75 μm | 125 μm | 250 μm | 500 μm | 750 μm |
| Inventive | A | Yes | 0.65 | 0.70 | 0.71 | 0.72 | 0.72 | 0.70 | 0.66 |
| Comparative | A | No | 0.42 | 0.51 | 0.51 | 0.52 | 0.53 | 0.51 | 0.45 |
| Inventive | B | Yes | 0.63 | 0.70 | 0.70 | 0.71 | 0.71 | — | — |
| Comparative | B | No | 0.40 | 0.49 | 0.50 | 0.51 | 0.51 | — | — |

It is understood from Table 1 that the scintillator panels of the present invention are high in the MFT values and are excellent in the image sharpness regardless of the thickness of the substrate.

What is claimed is:

1. A method of manufacturing a scintillator panel comprising the sequential steps of:
forming an electroconductive metal reflection layer on a polymer film substrate;
forming a protective layer on the electroconductive metal reflection layer;
cutting the polymer film substrate having thereon the electroconductive metal reflection layer and the protective layer into a prescribed size;
forming a scintillator layer by a vacuum evaporation method on the protective layer of the polymer film substrate cut in the prescribed size to prepare a scintillator sheet; and
sealing the scintillator sheet with sealing films provided above and below the scintillator sheet to prepare the scintillator panel,
wherein
static electricity is removed from the polymer film substrate through a cut surface of the electroconductive metal reflection layer when the scintillator layer is vacuum evaporated.

2. The method of claim 1, wherein the scintillator layer is formed using a raw material comprising cesium iodide and an additive containing thallium.

3. The method of claim 1, wherein a thickness of the polymer film substrate is 50 to 500 μm.

4. The method of claim 1, wherein the polymer film substrate comprises polyimide (PI) or polyethylene naphthalate (PEN).

5. The method of claim 1, wherein the electroconductive metal reflection layer comprises at least one element selected from the group consisting of Al, Ag, Cr, Cu, Hi, Mg, Pt and Au.

6. A scintillator panel manufactured by the method of claim 1.

7. A vacuum evaporation apparatus by which a scintillator layer is formed by a vacuum evaporation method according to the following steps:
forming an electroconductive metal reflection layer and a protective layer in that order on a polymer film substrate;
cutting the polymer film substrate into a prescribed size;
setting the polymer film substrate in a metal frame provided on a substrate holder, the metal frame being grounded; and
forming the scintillator layer on the polymer substrate by the vacuum evaporation method.
